(19) United States
(12) Patent Application Publication
(10) Pub. No.: US 2024/0275980 A1
(43) Pub. Date: Aug. 15, 2024

(54) METHOD, DEVICE, AND MEDIUM FOR VIDEO PROCESSING

(71) Applicants: Beijing Bytedanc Network Technology Co., Ltd., Beijing (CN); ByteDance Inc., Los Angeles, CA (US)

(72) Inventors: Yang WANG, Beijing (CN); Li ZHANG, Los Angeles, CA (US); Yuwen HE, Los Angeles, CA (US); Kai ZHANG, Los Angeles, CA (US)

(21) Appl. No.: 18/568,169

(22) PCT Filed: Jun. 8, 2022
(86) PCT No.: PCT/CN2022/097559

§ 371 Date: Dec. 7, 2023

(30) Foreign Application Priority Data
Jun. 10, 2021 (WO) PCT/CN2021/099530

(51) Int. Cl. H04N 19/137; H04N 19/105; H04N 19/172

(52) U.S. Cl. CPC H04N 19/137; H04N 19/105; H04N 19/172

(57) ABSTRACT

Embodiments of the present disclosure provide a solution for video processing is proposed. A method for video processing is proposed. The method comprises: determining, during a conversion between a video unit and a bitstream of the video unit, whether an optical flow based coding method is applied to the video unit based on illuminance information associated with at least one of: the video unit or a reference video unit of the video unit; and performing the conversion based on the determination. Compared with the conventional solution, the proposed method can advantageously improve the coding efficiency and performance.

### FIELD

Embodiments of the present disclosure relates generally to video coding techniques, and more particularly, to optical flow based coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a video unit and a bitstream of the video unit, whether an optical flow based coding method is applied to the video unit based on illuminance information associated with at least one of: the video unit or a reference video unit of the video unit; and performing the conversion based on the determination. The method in accordance with the first aspect of the present disclosure considers illuminance information when determining whether to or how to apply an optical flow based coding method, which can advantageously improve the coding efficiency and performance.

In a second aspect, an apparatus for processing video data is proposed. The apparatus comprises a processor and a non-transitory memory with instructions thereon, wherein the instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, a non-transitory computer-readable recording medium is proposed. The non-transitory computer-readable recording medium stores a bitstream of a video which is generated by a method performed by a video processing apparatus. The method comprises: determining whether an optical flow based coding method is applied to a video unit based on illuminance information associated with at least one of: the video unit or a reference video unit of the video unit; and generating a bitstream of the video unit based on the information.

In a fifth aspect, a method for storing a bitstream of a video is proposed. The method comprises: determining whether an optical flow based coding method is applied to a video unit based on illuminance information associated with at least one of: the video unit or a reference video unit of the video unit; generating a bitstream of the video unit based on the determination; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 is an example of encoder block diagram;

FIG. 5 is a schematic diagram of intra prediction modes;

FIG. 6 illustrates a block diagram of reference samples for wide-angular intra prediction;

FIG. 7 illustrates a block diagram of discontinuity in case of directions beyond 45 degree;

FIG. 8 illustrates a block diagram of extended coding unit (CU) region used in bidirectional optical flow (BDOF);

FIG. 9 shows control point based affine motion model;

FIG. 10 shows affine MVF per subblock;

FIG. 11 illustrates a block diagram of locations of inherited affine motion predictors;

FIG. 12 illustrates a block diagram of control point motion vector inheritance;

FIG. 13 illustrates a block diagram of locations of candidates position for constructed affine merge mode;

FIG. 14 is an illustration of motion vector usage for proposed combined method;

FIG. 15 shows subblock MV V_{SB} and pixel Δv(i,j);

FIG. 16 illustrates a block diagram of local illumination compensation;

FIG. 17 shows no subsampling for the short side;

FIG. 18 illustrates a block diagram of decoding side motion vector refinement;

FIG. 19 illustrates a block diagram of diamond regions in the search area;

FIG. 20 illustrates a block diagram of positions of spatial merge candidate;

FIG. 21 illustrates a block diagram of candidate pairs for redundancy check of spatial merge candidate;

FIG. 22 is an illustration of motion vector scaling for temporal merge candidate;

FIG. 23 illustrates a block diagram of candidate positions for temporal merge candidate, C0 and C1;

FIG. 24 shows a VVC spatial neighboring blocks of the current block;

FIG. 25 illustrates a virtual block in the i-th search round;

FIG. 26 illustrates a flowchart of a method 2600 for video processing in accordance with some embodiments of the present disclosure;

FIG. 27 illustrates a flowchart of a method 2700 for video processing in accordance with some embodiments of the present disclosure;

FIG. 28 illustrates a flowchart of a method 2800 for video processing in accordance with some embodiments of the present disclosure;

FIG. 29 illustrates a flowchart of a method 2900 for video processing in accordance with some embodiments of the present disclosure; and

FIG. 30 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”. “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

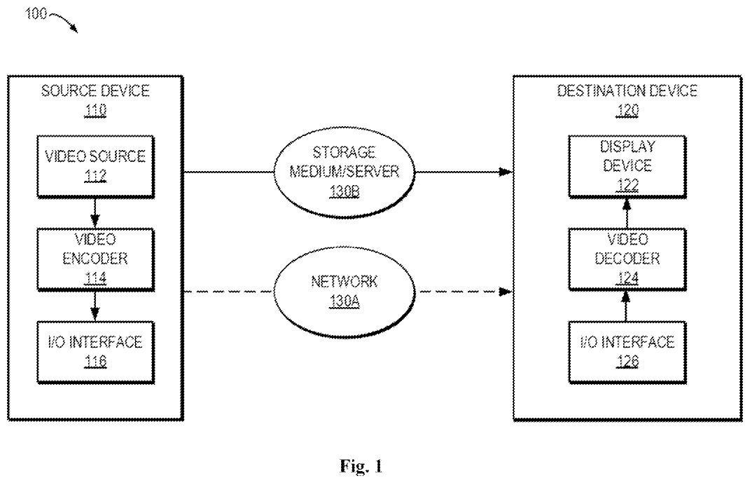

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

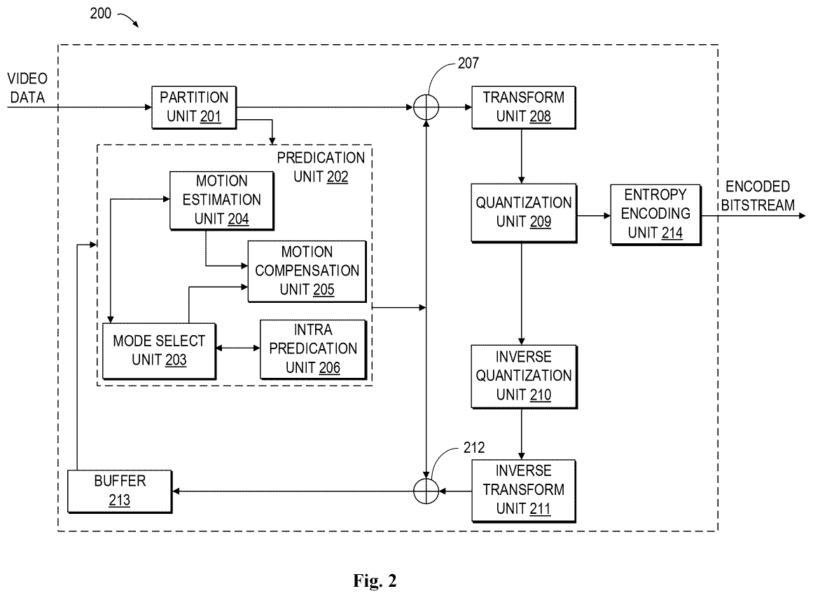

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list (or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bidirectional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list (and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

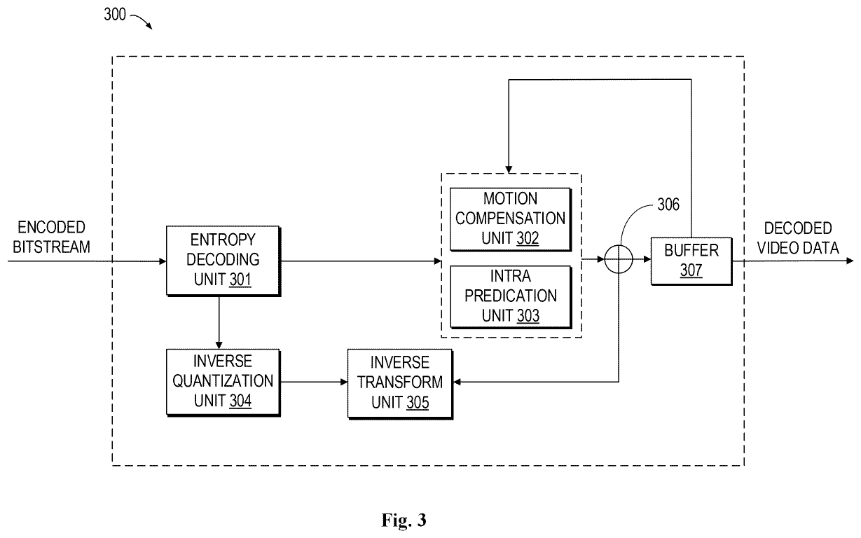

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for subinteger pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

The present disclosure is related to video coding technologies. Specifically, it is related optical flow based coding methods considering illuminance change, how to and/or whether to apply an optical flow based coding method depends on illuminance information, and other coding tools in image/video coding. It may be applied to the existing video coding standard like HEVC, or Versatile Video Coding (VVC). It may be also applicable to future video coding standards or video codec.

### 2. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. The latest version of VVC draft, i.e., Versatile Video Coding (Draft 10) could be found at: http://phenix.it-sudparis.eu/jvet/doc_end_user/documents/20_Teleconference/wg11/JVET-T2001-v1.zip

The latest reference software of VVC, named VTM, could be found at: https://vcgit.hhi.fraunhofer.de/jvet/VVCSoftware_VTM/-/tags/VTM-11.0

### 2.1. Coding Flow of a Typical Video Codec

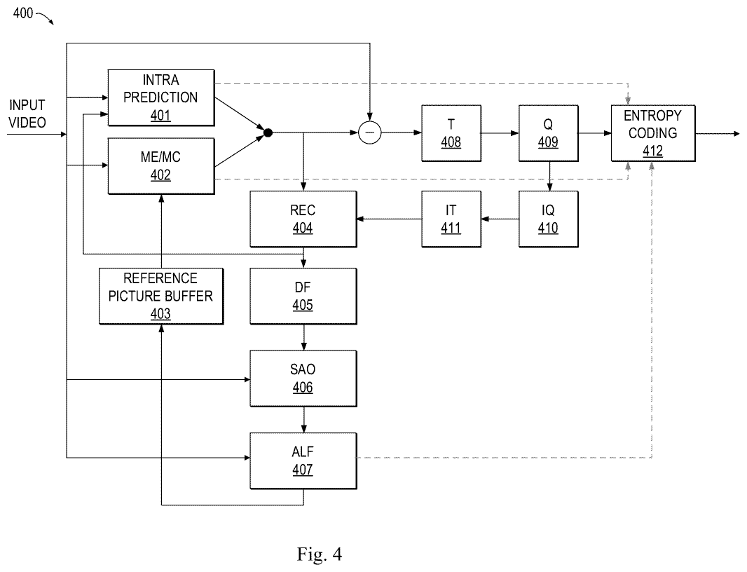

FIG. 4 shows an example of encoder block diagram of VVC, which contains three in-loop filtering blocks; deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 2.2. Intra Mode Coding With 67 Intra Prediction Modes

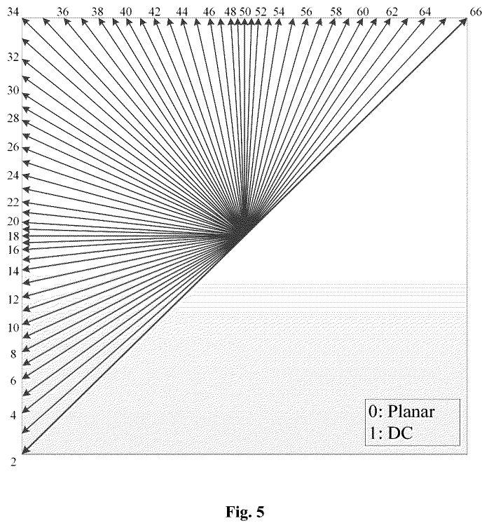

To capture the arbitrary edge directions presented in natural video, the number of directional intra modes is extended from 33, as used in HEVC, to 65, as shown in FIG. 5, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.2.1. Wide Angle Intra Prediction

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wideangle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

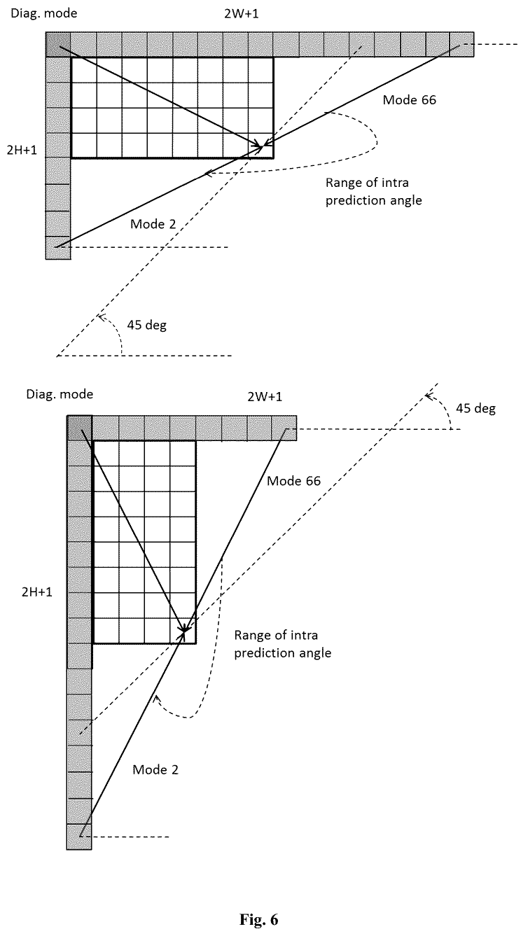

To support these prediction directions, the top reference with length 2W+1, and the left reference with length 2H+1, are defined as shown in FIG. 6.

The number of replaced modes in wide-angular direction mode depends on the aspect ratio of a block. The replaced intra prediction modes are illustrated in Table 1.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, |
| | 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode |
| | 57, 58, 59, 60, 61, 62, 63, 64, 65, 66 |
| W/H == ⅛ | Modes 55, |
| | 56, 57, 58, 59, 60, 61, 62, 63, 64, 65, 66 |
| W/H == 1/16 | Modes 53, 54, 55, |
| | 56, 57, 58, 59, 60, 61, 62, 63, 64, 65, 66 |

FIG. 7 illustrates a block diagram of discontinuity in case of directions beyond 45 degree. As shown in the diagram 700 of FIG. 7, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Apa. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.3. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any interpredicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBCcoded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs. At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.5. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order
The distances (i.e. POC difference) from two reference pictures to the current picture are same
Both reference pictures are short-term reference pictures.
The CU is not coded using affine mode or the SbTMVP merge mode
CU has more than 64 luma samples
Both CU height and CU width are larger than or equal to 8 luma samples
BCW weight index indicates equal weight
WP is not enabled for the current CU
CIIP mode is not used for the current CU

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process. First, the horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \\ \frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) ) \qquad ( 2 - 1 )$$

where I^{(k)}(i,j) are the sample value at coordinate (i,j) of the prediction signal in list k, k=0,1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) ) \\ {S}_{2} = {\sum }_{( i , j ) ∈ Ω} {ψ}_{x} ( i , j ) \cdot Sign ( {ψ}_{y} ( i , j ) ) \\ {S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) ) \qquad ( 2 - 2 )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \\ {ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \\ θ ( i , j ) = ( {I}^{( 1 )} ( i , j ) ≫ {n}_{b} ) - ( {I}^{( 0 )} ( i , j ) ≫ {n}_{b} ) \qquad ( 2 - 3 )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0 \\ {v}_{y} = {S}_{5} > 0 ? clip 3 ( - {th}_{BIO}^{′} , {th}_{BIO}^{′} , \\ - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0 \\ where {S}_{2 , m} = {S}_{2} ≫ {n}_{{S}_{2}} , {S}_{2 , s} = {S}_{2} \& ( {2}^{{n}_{{S}_{2}}} - 1 ) , {th}_{BIO}^{′} = {2}^{max ( 5 , BD - 7 )} . \qquad ( 2 - 4 )$$

└·┘ is the floor function, and nₛ_{₂}=12.

Based on the motion refinement and the gradients, the following adjustment is calculated for each sample in the 4×4 subblock:

$$b ( x , y ) = \qquad ( 2 - 5 )$$

$$rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift \qquad ( 2 - 6 )$$

These values are selected such that the multipliers in the BDOF process do not exceed 15-bit, and the maximum bit-width of the intermediate parameters in the BDOF process is kept within 32-bit.

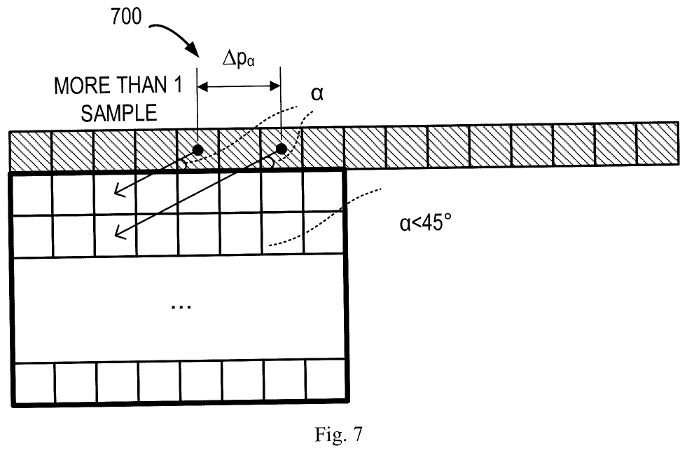

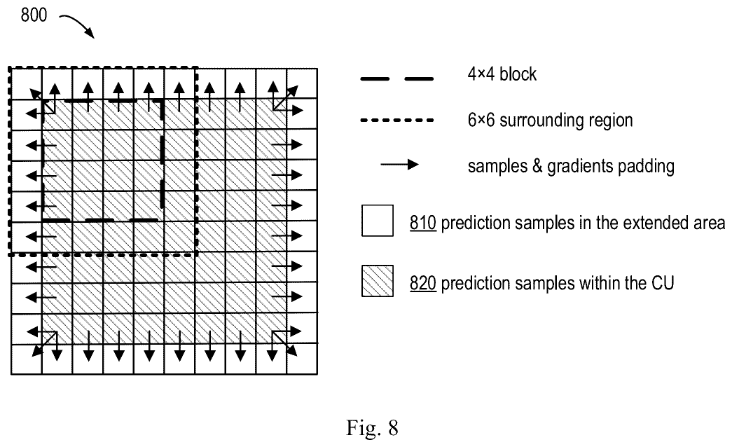

In order to derive the gradient values, some prediction samples I^{(k)}(i,j) in list k (k=0,1) outside of the current CU boundaries need to be generated. FIG. 8 illustrates a schematic diagram of extended CU region used in BDOF. As depicted in the diagram 800 of FIG. 8, the BDOF in VVC uses one extended row/column around the CU's boundaries. In order to control the computational complexity of generating the out-of-boundary prediction samples, prediction samples in the extended area (denoted as 810 in FIG. 8) are generated by taking the reference samples at the nearby integer positions (using floor( ) operation on the coordinates) directly without interpolation, and the normal 8-tap motion compensation interpolation filter is used to generate prediction samples within the CU (denoted as 820 in FIG. 8). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_1x_flag is 1 for either of the two reference pictures, then BDOF is also disabled. When a CU is coded with symmetric MVD mode or CIIP mode, BDOF is also disabled.

### 2.6. Affine Motion Compensated Prediction

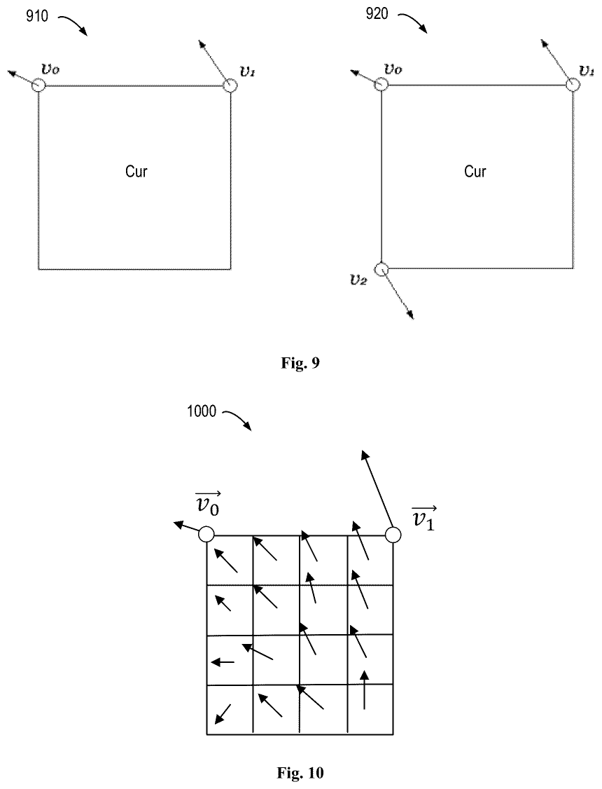

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIG. 9, the affine motion field of the block is described by motion information of two control point (4-parameter) or three control point motion vectors (6-parameter).

For 4-parameter affine motion model 910 in FIG. 9, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} \qquad ( 2 - 7 )$$

For 6-parameter affine motion model 920 in FIG. 9, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 - 8 )$$

Where (mv₀ₓ, mv_{0y}) is motion vector of the top-left corner control point, (mv₁ₓ, mv_{1y}) is motion vector of the top-right corner control point, and (mv₂ₓ, mv₂ₓ) is motion vector of the bottom-left corner control point.

In order to simplify the motion compensation prediction, block based affine transform prediction is applied. FIG. 10 illustrates a schematic diagram 1000 of affine MVF per subblock. To derive motion vector of each 4×4 luma subblock, the motion vector of the center sample of each subblock, as shown in FIG. 10, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the four corresponding 4×4 luma subblocks.

As done for translational motion inter prediction, there are also two affine motion inter prediction modes: affine merge mode and affine AMVP mode.

### 2.6.1. Affine Merge Prediction

AF_MERGE mode can be applied for CUs with both width and height larger than or equal to 8. In this mode the CPMVs of the current CU is generated based on the motion information of the spatial neighbouring CUs. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour CUS
Constructed affine merge candidates CPMVPs that are derived using the translational MVs of the neighbour CUs
Zero MVs

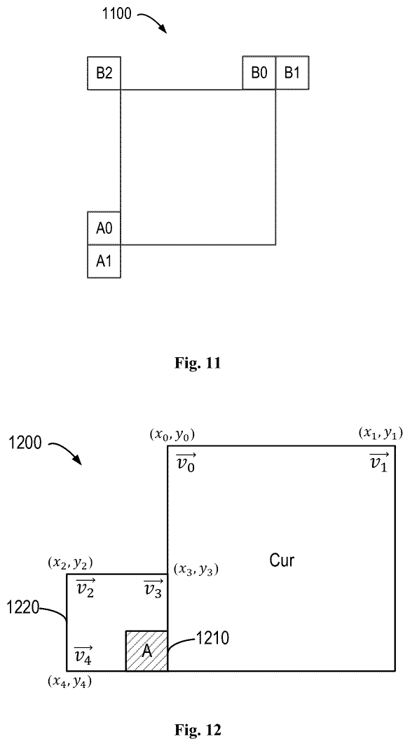

In VVC, there are maximum two inherited affine candidates, which are derived from affine motion model of the neighbouring blocks, one from left neighbouring CUs and one from above neighbouring CUs. FIG. 11 illustrates a schematic diagram 1100 of locations of inherited affine motion predictors. The candidate blocks are shown in FIG. 11. For the left predictor, the scan order is A0->A1, and for the above predictor, the scan order is B0->B1->B2. Only the first inherited candidate from each side is selected. No pruning check is performed between two inherited candidates. When a neighbouring affine CU is identified, its control point motion vectors are used to derive the CPMVP candidate in the affine merge list of the current CU. FIG. 12 illustrates a schematic diagram 1200 of control point motion vector inheritance. As shown in 12, if the neighbour left bottom block A 1210 is coded in affine mode, the motion vectors v₂, v₃ and v₄ of the top left corner, above right corner and left bottom corner of the CU 1220 which contains the block A 1210 are attained. When block A 1210 is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

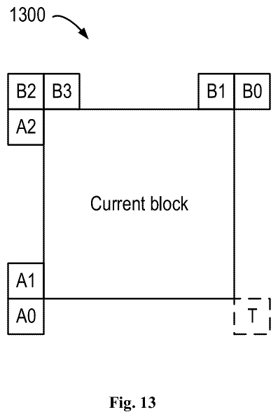

Constructed affine candidate means the candidate is constructed by combining the neighbour translational motion information of each control point. The motion information for the control points is derived from the specified spatial neighbours and temporal neighbour shown in FIG. 13 which illustrates a schematic diagram 1300 of locations of candidates position for constructed affine merge mode. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available.

After MVs of four control points are attained, affine merge candidates are constructed based on that motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.6.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighbouring CUs
Zero MVs

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbours shown in FIG. 13. The same checking order is used as done in affine merge candidate construction. In addition, reference picture index of the neighbouring block is also checked. The first block in the checking order that is inter coded and has the same reference picture as in current CUs is used. There is only one When the current CU is coded with 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

If affine AMVP list candidates is still less than 2 after inherited affine AMVP candidates and Constructed AMVP candidate are checked, mv₀, mv₁, and mv₂ will be added, in order, as the translational MVs to predict all control point MVs of the current CU, when available. Finally, zero MVs are used to fill the affine AMVP list if it is still not full.

### 2.6.3. Affine Motion Information Storage

In VVC, the CPMVs of affine CUs are stored in a separate buffer. The stored CPMVs are only used to generate the inherited CPMVPs in affine merge mode and affine AMVP mode for the lately coded CUs. The subblock MVs derived from CPMVs are used for motion compensation, MV derivation of merge/AMVP list of translational MVs and de-blocking.

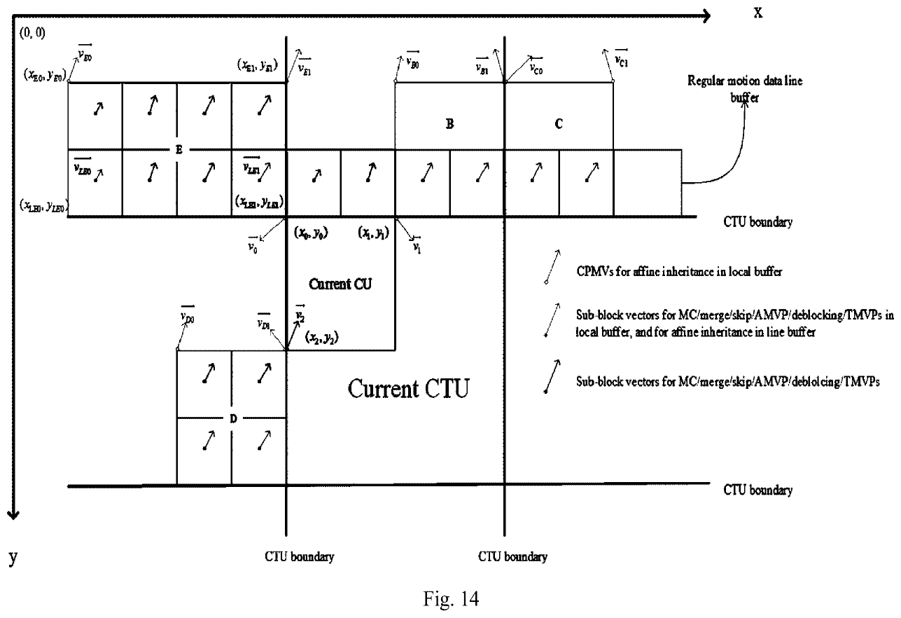

To avoid the picture line buffer for the additional CPMVs, affine motion data inheritance from the CUs from above CTU is treated differently to the inheritance from the normal neighbouring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. As shown in FIG. 14, along the top CTU boundary, the bottom-left and bottom right subblock motion vectors of a CU are used for affine inheritance of the CUs in bottom CTUs.

### 2.6.4. Prediction Refinement With Optical Flow for Affine Mode

Subblock based affine motion compensation can save memory access bandwidth and reduce computation complexity compared to pixel-based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:

Step 1) The subblock-based affine motion compensation is performed to generate subblock prediction I(i,j).

Step 2) The spatial gradients gₓ(i,j) and g_{y}(i,j) of the subblock prediction are calculated at each sample location using a 3-tap filter [−1, 0, 1]. The gradient calculation is exactly the same as gradient calculation in BDOF.

$${g}_{x} ( i , j ) = ( I ( i + 1 , j ) ≫ shift 1 ) - ( I ( i - 1 , j ) ≫ shift 1 ) \qquad ( 2 - 9 )$$

$${g}_{y} ( i , j ) = ( I ( i , j + 1 ) ≫ shift 1 ) - ( I ( i , j - 1 ) ≫ shift 1 ) \qquad ( 2 - 10 )$$

shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.

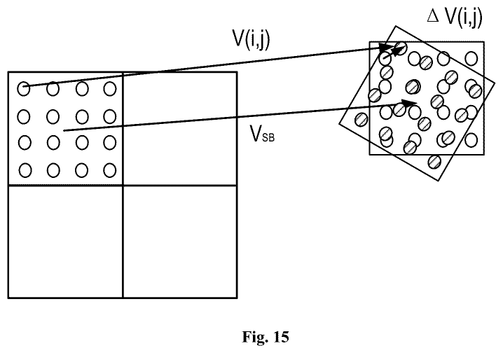

Step 3) The luma prediction refinement is calculated by the following optical flow equation.

$$Δ I ( i , j ) = {g}_{x} ( i , j ) * Δ {v}_{x} ( i , j ) + {g}_{y} ( i , j ) * Δ {v}_{y} ( i , j ) \qquad ( 2 - 11 )$$

where the Δv(i,j) is the difference between sample MV computed for sample location (i,j), denoted by v(i,j), and the subblock MV of the subblock to which sample (i,j) belongs, as shown in FIG. 15. The Δv(i,j) is quantized in the unit of 1/32 luam sample precision.

Since the affine model parameters and the sample location relative to the subblock center are not changed from subblock to subblock, Δv(i,j) can be calculated for the first subblock, and reused for other subblocks in the same CU. Let dx(i,j) and dy(i,j) be the horizontal and vertical offset from the sample location (i,j) to the center of the subblock (x_{SB}, y_{SB}), Δv(x,y) can be derived by the following equation,

$$\{ \begin{matrix}dx ( i , j ) = i - {x}_{SB} \\ dy ( i , j ) = j - {y}_{SB}\end{matrix} \qquad ( 2 - 12 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} \qquad ( 2 - 13 )$$

In order to keep accuracy, the enter of the subblock (x_{SB}, y_{SB}) is calculated as ((W_{SB}−1)/2, (H_{SB}−1)/2), where W_{SB} and H_{SB} are the subblock width and height, respectively.

For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad ( 2 - 14 )$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 2 - 15 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.

Step 4) Finally, the luma prediction refinement ΔI(i,j) is added to the subblock prediction I(i,j). The final prediction I′ is generated as the following equation.

$${I}^{′} ( i , j ) = I ( i , j ) + Δ I ( i , j ) \qquad ( 2 - 16 )$$

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 2.7. Bi-Prediction With CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) ≫ 3 \qquad ( 2 - 17 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. For further details readers are referred to the VTM software and document JVET-L0646. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g., equal weight.

### 2.8. Local Illumination Compensation (LIC)

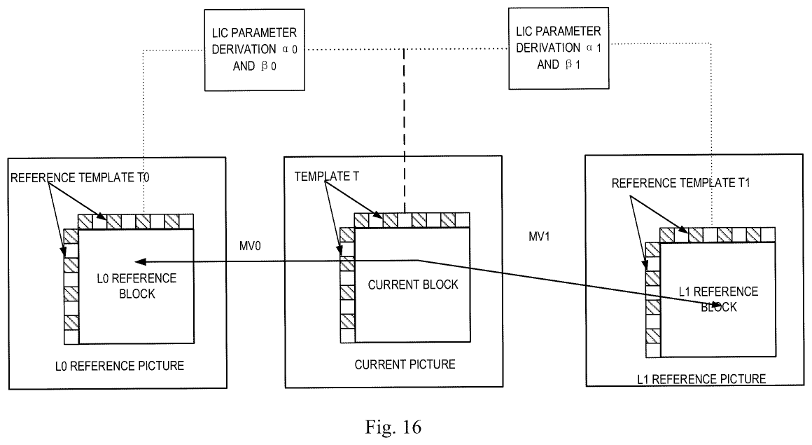

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

$$P ( x , y ) = α \cdot {P}_{r} ( x + {v}_{x} , y + {v}_{y} ) + β$$

where P(x,y) is the prediction signal of the current block at the coordinate (x,y); Pᵣ(x+vₓ, y+v_{y}) is the reference block pointed by the motion vector (vₓ,v_{y}); α and β are the corresponding scaling factor and offset that are applied to the reference block. FIG. 16 illustrates the LIC process. In FIG. 16, when the LIC is applied for a block, a least mean square error (LMSE) method is employed to derive the values of the LIC parameters (i.e., α and β) by minimizing the difference between the neighboring samples of the current block (i.e., the template T in FIG. 16) and their corresponding reference samples in the temporal reference pictures (i.e., either T0 or T1 in FIG. 16). Additionally, to reduce the computational complexity, both the template samples and the reference template samples are subsampled (adaptive subsampling) to derive the LIC parameters, i.e., only the shaded samples in FIG. 16 are used to derive α and β.

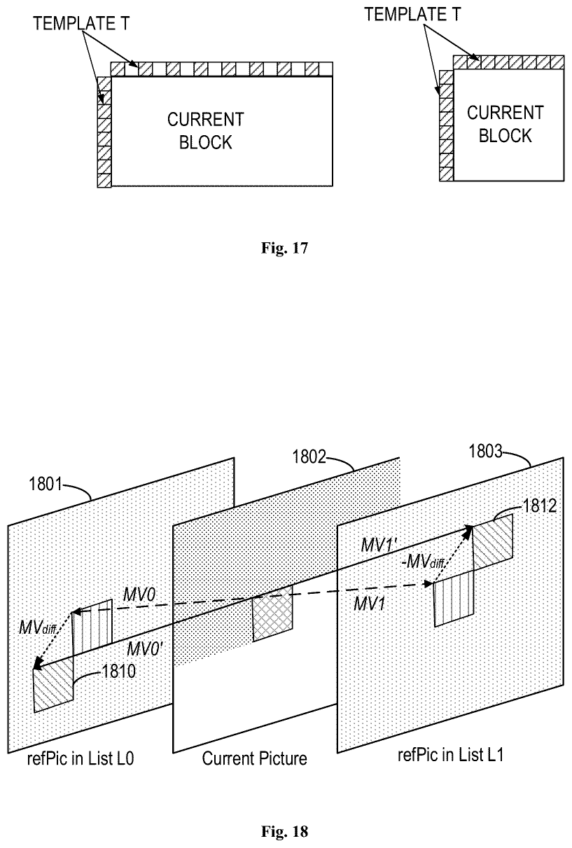

To improve the coding performance, no subsampling for the short side is performed as shown in FIG. 17.

### 2.9. Decoder Side Motion Vector Refinement (DMVR)

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. FIG. 18 is a schematic diagram illustrating the decoding side motion vector refinement. As illustrated in FIG. 18, the SAD between the blocks 1810 and 1812 based on each MV candidate around the initial MV is calculated, where the block 1810 is in a reference picture 1801 in the list L0 and the block 1812 is in a reference picture 1803 in the List L1 for the current picture 1802. The MV candidate with the lowest SAD becomes the refined MV and used to generate the bi-predicted signal.

In VVC, the application of DMVR is restricted and is only applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.9.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 2 - 18 )$$

$$MV {1}^{′} = MV 1 - MV\_offset \qquad ( 2 - 19 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C \qquad ( 2 - 20 )$$

where (xₘᵢₙ,yₘᵢₙ) corresponds to the fractional position with the least cost and C corresponds to the minimum cost value. By solving the above equations by using the cost value of the five search points, the (xₘᵢₙ,yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 2 - 21 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 2 - 22 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ,yₘᵢₙ) are added to the integer distance refinement MV to get the sub-pixel accurate refinement delta MV.

### 2.9.2. Bilinear-Interpolation and Sample Padding

In VVC, the resolution of the MVs is 1/16 luma samples. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.9.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.10. Multi-Pass Decoder-Side Motion Vector Refinement

In this contribution, a multi-pass decoder-side motion vector refinement is applied instead of DMVR. In the first pass, bilateral matching (BM) is applied to a coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.10.1. First Pass—Block Based Bilateral Matching MV Refinement

In the first pass, a refined MV is derived by applying BM to a coding block. Similar to decoderside motion vector refinement (DMVR), the refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV and half-pel sample precision halfDeltaMv. The local search applies a 3×3 square search pattern to loop through the search range [−sHor, sHor] in a horizontal direction and [−sVer, sVer] in a vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of the distortion between the reference blocks. When the bilCost at the center point of the 3×3 search pattern has the minimum cost, the intDeltaMV or halfDeltaMV local search is terminated. Otherwise, the current minimum cost search point becomes the new center point of the 3×3 search pattern and the search for the minimum cost continues, until it reaches the end of the search range.

The existing fractional sample refinement is further applied to derive the final deltaMV. The refined MVs after the first pass are then derived as:

$$MV0\_pass1 = MV 0 + deltaMV$$

$$MV1\_pass1 = MV 1 - deltaMV$$

### 2.10.2. Second Pass—Subblock Based Bilateral Matching MV Refinement

In the second pass, a refined MV is derived by applying BM to a 16×16 grid subblock. For each subblock, the refined MV is searched around the two MVs (MV0_pass1 and MV1_pass1), obtained on the first pass for the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in a horizontal direction and [−sVer, sVer] in a vertical direction, wherein, the values of sHor and sVer are determined by the block dimension, and the maximum value of sHor and sVer is 8.

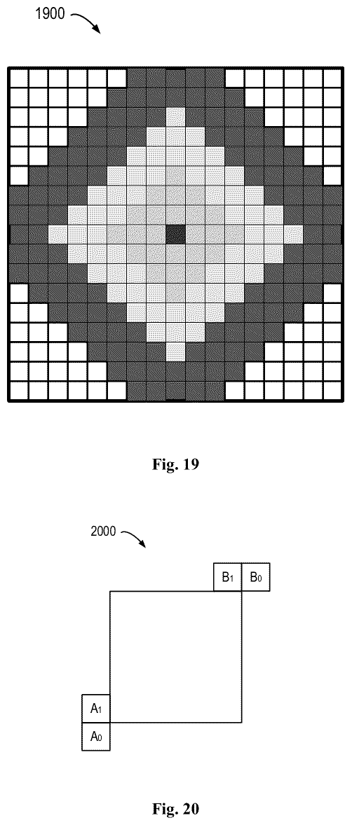

The bilateral matching cost is calculated by applying a cost factor to the SATD cost between the two reference subblocks, as: bilCost=satdCost*costFactor. The search area (2*sHor+1)*(2*sVer+1) is divided up to 5 diamond shape search regions shown in in the diagram 1900 of FIG. 19. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.

BM performs local search to derive half sample precision halfDeltaMv. The search pattern and cost function are the same as defined in 2.9.1.

The existing VVC DMVR fractional sample refinement is further applied to derive the final deltaMV(sbIdx2). The refined MVs at second pass is then derived as:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 )$$

### 2.10.3. Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:

$$MV0\_pass3 ( sbIdx 3 ) = MV0\_pass2 ( sbIdx 2 ) + bioMv$$

$$MV1\_pass3 ( sbIdx 3 ) = MV0\_pass2 ( sbIdx 2 ) - bioMv$$

### 2.11. Sample-Based BDOF

In the sample-based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### 2.12. Extended Merge Prediction

In VVC, the merge candidate list is constructed by including the following five types of candidates in order:
(1) Spatial MVP from spatial neighbour CUs
(2) Temporal MVP from collocated CUs
(3) History-based MVP from a FIFO table
(4) Pairwise average MVP
(5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.12.1. Spatial Candidates Derivation

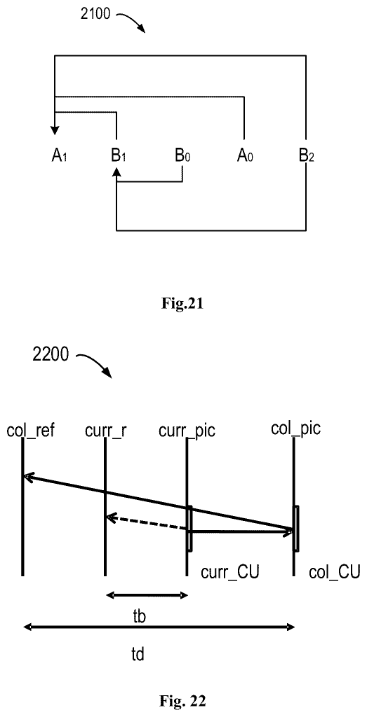

The derivation of spatial merge candidates in VVC is same to that in HEVC except the positions of first two merge candidates are swapped. FIG. 20 is a schematic diagram 2000 illustrating positions of a spatial merge candidate. A maximum of four merge candidates are selected among candidates located in the positions depicted in FIG. 20. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 21 is a schematic diagram 2100 illustrating candidate pairs considered for redundancy check of spatial merge candidates. Instead only the pairs linked with an arrow in FIG. 21 are considered and a candidate is only added to the list if the corresponding candidate used for redundancy check has not the same motion information.

### 2.12.2. Temporal Candidates Derivation

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in the diagram 2200 of FIG. 22, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

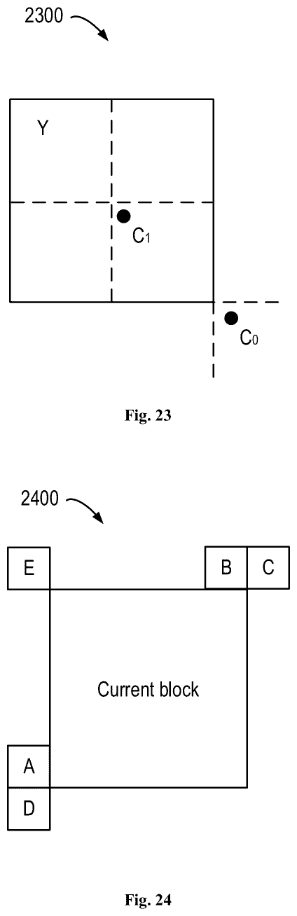

FIG. 23 is a schematic diagram 2300 illustrating candidate positions for temporal merge candidate, C₀ and C₁. The position for the temporal candidate is selected between candidates C0 and C1, as depicted in FIG. 23. If CU at position C0 is not available, is intra coded, or is outside of the current row of CTUs, position C1 is used. Otherwise, position C0 is used in the derivation of the temporal merge candidate.

### 2.12.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:

Number of HMPV candidates is used for merge list generation is set as (N<=4)?M:(8−N), wherein N indicates number of existing candidates in the merge list and M indicates number of available HMVP candidates in the table.

Once the total number of available merge candidates reaches the maximally allowed merge candidates minus 1, the merge candidate list construction process from HMVP is terminated.

### 2.12.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.12.5. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cbWidth, cbHeight) is the CU size. The MER size is selected at encoder side and signalled as log 2_parallel_merge_level_minus2 in the sequence parameter set.

### 2.13. New Merge Candidates

### 2.13.1. Non-Adjacent Merge Candidates Derivation

FIG. 24 illustrates a schematic diagram 2400 of VVC spatial neighboring blocks of the current block. In VVC, five spatially neighboring blocks shown in FIG. 24 as well as one temporal neighbor are used to derive merge candidates.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:

$$Offset x = - i \times grid X , Offset y = - i \times grid Y$$

where the Offsetx and Offsety denote the offset of the top-left corner of the virtual block relative to the top-left corner of the current block, gridX and gridY are the width and height of the search grid.

Second, the width and height of the virtual block are calculated by:

$$new Width = i \times 2 \times grid X + curr Width new Height = i \times 2 \times grid Y + curr Height .$$

where the currWidth and currHeight are the width and height of current block. The new Width and newHeight are the width and height of new virtual block.
gridX and gridY are currently set to currWidth and currHeight, respectively.

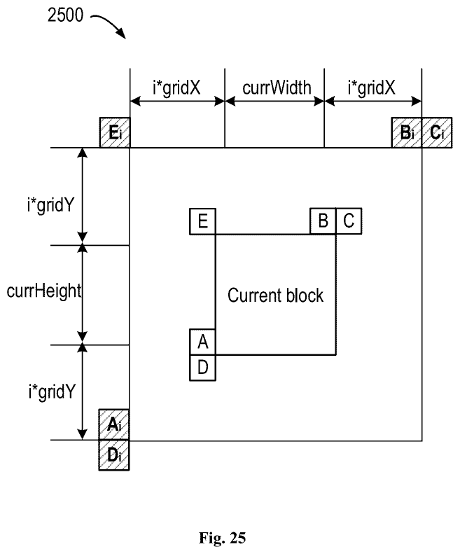

FIG. 25 illustrates a schematic diagram of a virtual block in the ith search round, which shows the relationship between the virtual block and the current block.

After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.

When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁->A₁->C₁->D₁->E₁.

### 2.13.2. STMVP

It is proposed to derive an averaging candidate as STMVP candidate using three spatial merge candidates and one temporal merge candidate.

STMVP is inserted before the above-left spatial merge candidate.

The STMVP candidate is pruned with all the previous merge candidates in the merge list.

For the spatial candidates, the first three candidates in the current merge candidate list are used.

For the temporal candidate, the same position as VTM/HEVC collocated position is used.

For the spatial candidates, the first, second, and third candidates inserted in the current merge candidate list before STMVP are denoted as F, S, and, T.

The temporal candidate with the same position as VTM/HEVC collocated position used in TMVP is denoted as Col.

The motion vector of the STMVP candidate in prediction direction X (denoted as mvLX) is derived as follows:
1) If the reference indices of the four merge candidates are all valid and are all equal to zero in prediction direction X (X=0 or 1),

$$mvLX = ( mvLX\_F + mvLX\_S + mvLX\_T + mvLX\_Col ) ≫ 2$$

2) If reference indices of three of the four merge candidates are valid and are equal to zero in prediction direction X (X=0 or 1),

$$mvLX = ( mvLX\_F \times 3 + mvLX\_S \times 3 + mvLX\_Col \times 2 ) ≫ 3 or$$

$$mvLX = ( mvLX\_F \times 3 + mvLX\_T \times 3 + mvLX\_Col \times 2 ) ≫ 3 or$$

$$mvLX = ( mvLX\_S \times 3 + mvLX\_T \times 3 + mvLX\_Col \times 2 ) ≫ 3$$

3) If reference indices of two of the four merge candidates are valid and are equal to zero in prediction direction X (X=0 or 1),

$$mvLX = ( mvLX\_F + mvLX\_Col ) ≫ 1 or$$

$$mvLX = ( mvLX\_S + mvLX\_Col ) ≫ 1 or$$

$$mvLX = ( mvLX\_T + mvLX\_Col ) ≫ 1$$

Note: If the temporal candidate is unavailable, the STMVP mode is off.

### 2.13.3. Merge List Size

If considering both non-adjacent and STMVP merge candidates, the size of merge list is signalled in sequence parameter set header and the maximum allowed size of merge list is 8.

### 3. Problems

In current design of current optical flow based coding methods (e.g., bi-directional optical flow (BDOF) and prediction refinement with optical flow (PROF)), the illuminance change is not considered. How to deal with optical flow based coding methods when illuminance change occurs needs to be explored.

### 4. Embodiments of the Present Disclosure

The detailed embodiments below should be considered as examples to explain general concepts. These embodiments should not be interpreted in a narrow way. Furthermore, these embodiments can be combined in any manner.

### On Determination of Optical Flow Based Coding Methods Using Illuminance Information

1. Whether to apply an optical flow based coding method to a video unit may depend on whether illuminance change occurs.
a. In one example, the optical flow based coding method may not be applied to the video unit when illuminance change occurs.
   i. In one example, how to detect the illuminance change may depend on neighbouring samples (adjacent or non-adjacent) of the video unit.
   ii. In one example, whether the illuminance change of the video unit occurs may be indicated by a syntax element and signalled in the bitstream.
   iii. In one example, whether the illuminance change of the video unit occurs may depend on whether and/or how a certain coding tool (such as LIC and BCW) is applied.
   iv. In one example, the optical flow based coding method may be not applied to a sample/pixel of the video unit when there is change on the illuminance of the sample/pixel.

2. How to apply an optical flow based coding method to a video unit may depend on whether illuminance change occurs.
a. In one example, the illuminance change may be included in the process of the optical flow based coding method.
   i. In one example, a value may be subtracted when calculating the gradients in the process of the optical flow based coding method.
   ii. In one example, when calculating the difference of a sample/pixel in a first prediction block and a sample/pixel in a second prediction block, a first value may be firstly subtracted from the sample/pixel in the first prediction block and a second value may be firstly subtracted from the sample/pixel in the second prediction block.
   iii. Instead of using the first/second prediction blocks directly obtained from motion information, it is proposed to firstly revise the obtained prediction blocks via a function, i.e. f(Pi) is used in the optical flow procedure, instead of the sample value Pi.
      1) In one example, the function is a linear function, (e.g., f(Pi)=a*Pi+b) wherein a and b are the linear parameters, and Pi denotes a sample/pixel in the prediction blocks.
      2) In one example, a and/b may be determined by coding tools such as LIC and BCW.
      3) Alternatively, furthermore, the linear parameter (a, b) may be derived using neighbouring samples/pixels.
      4) Alternatively, furthermore, the linear parameter (a, b) may be signalled.
      5) Alternatively, furthermore, the linear parameter sets (a, b) may be different for the two prediction blocks.
      6) Alternatively, furthermore, the obtained prediction blocks may be revised using a non-linear function, such as polynomial functions.
   iv. The model parameters, such as linear model, of illumination change may be jointly optimized with the optical flow parameters jointly.
      1) The luminance change model parameters and optical flow parameters of one block may be solved with least square regression method iteratively.

3. The detection and/or calculation of illumination changes may be performed in a first level, and the decision of how to and/or whether to apply the optical flow based coding method may be done in a second level.
a. In one example, the 1^{st}/2^{nd} levels are both block level.
b. In one example, the 1^{st}/2^{nd} levels are both picture level.
c. In one example, the 1^{st}/2^{nd} levels are both sub-block level.
d. In one example, the 1^{st} level is block level, and the 2^{nd} level is sub-block level.
e. In one example, all samples/pixels in the first level may be utilized.
   i. Alternatively, partial of them may be utilized.

4. For the block-level optical flow based coding method, the detection and/or calculation of illumination changes may involve more samples in addition to the prediction blocks of the current block.

5. For the subblock-level optical flow based coding method, the detection and/or calculation of illumination changes may involve more samples in addition to the prediction blocks of the current subblock in a block.

6. Whether to and/or how to apply the optical flow based coding method to the video unit may depend on whether and/or how a coding tool solving illumination changes (e.g., BCW, LIC) is applied to the video unit.
a. In one example, the coding tool may refer to a local illumination compensation method, and/or a bi-prediction with CU-level weight method, and/or affine compensation method.
b. In one example, the optical flow based coding method may not be applied when the coding tool is applied to the video unit.
c. In one example, the optical flow based coding method may be applied to the video unit when the coding tool is applied to the video unit.

7. In one example, whether to enable the optical flow based coding method for a video unit may depend on the illuminance information of the video unit and/or the reference video unit.
a. In one example, whether to enable the optical flow based coding method for a video unit may depend on the illumination information of two reference pictures.
   i. In one example, if illumination changes occurs among the two reference pictures, it is disallowed to enable the optical flow based coding method.
   ii. In one example, one of the two reference pictures is from list X, and the other is from list Y.
   iii. In one example, the absolute POC distance of the two reference pictures is equal to twice of the absolute POC distance of one reference picture relative to the current video unit.
   iv. When calculating illumination information, all samples/pixels or partial of them in the two reference pictures may be utilized.
b. In one example, the video unit may refer to picture/subpicture/tile/slice/coding tree unit/a group of coding tree units/coding unit.
c. In one example, whether to enable the optical flow based coding method for a video unit may depend on the illumination information of current picture and one or more reference pictures.
   i. In one example, the determination of whether illuminance change occurs depends on the current picture and/or one or more reference pictures.
      1) In one example, the original samples or reconstructed samples in the reference pictures may be used to determine whether illuminance change occurs.
      2) In one example, the original samples or partial reconstructed samples or prediction samples of current picture may be used to determine whether illuminance change occurs.
      3) In one example, histograms are calculated for one or more reference pictures, and it is determined illumination changes occurs when the difference of the histograms is larger than T.
         a) In one example, T may be set adaptively dependent on the size of the current picture.
         b) In one example, T may depend on the coding information.
         c) In one example, T may depend on current picture.
         d) In one example, T may be calculated using the histograms of current picture and the reference pictures.
   ii. In one example, if illumination change occurs among current picture and the reference pictures, it is disallowed to enable the optical flow based coding method.
d. In one example, the illuminance information may refer to the sample values of one or more components between the video unit and its reference video unit.
   i. In one example, the component may refer to luma component.
   ii. In one example, the component may refer to one or more chroma components.
   iii. In one example, the video unit and/or the reference video unit may be a coding block, such as coding unit/prediction unit/transform unit.
   iv. In one example, a first feature of sample value is calculated for the video unit, and a second feature of sample value is calculated for the reference video unit. When the difference of the first feature and the second feature is larger than T, the optical flow based method may be not applied to the video unit.
      1) In one example, the first feature for the video unit may be calculated using neighbouring samples (adjacent or non-adjacent) of the video unit.
         a) Alternatively, a prediction signal may be derived for the video unit (e.g., intra prediction), and the first feature of the video unit may be calculated using the prediction signal.
      2) In one example, the second feature may be calculated using the reconstructed samples of the reference unit.
      3) In one example, the feature may refer to the mean value, and/or variance value.
      4) In one example, the feature may refer to the histogram of sample values.
      5) In one example, the determination of T may depend on coding information.
         a) In one example, the coding information may refer to the dimension, and/or size of the video unit.

8. In above examples, the optical flow based coding method may refer to a bi-directional optical flow method in which the optical flow is used to refine the bi-prediction signal of a coding block, and/or a prediction refinement with optical flow for affine mode in which the optical flow is used to refine the affine motion compensated prediction, and/or other coding methods in which the optical flow is used to generate/refine the prediction/reconstruction signal of a coding block.
a. In one example, it may be the PROF.
b. In one example, it may be the BDOF.

9. The term of “illuminance change” of a sample/pixel may refer to the sample/pixel value changes a lot between two different video units (e.g., current picture and its reference picture). For example, d=abs(P1−P2) where P1 and P2 denote two samples/pixels in two different video units, illuminance change occurs when d is larger than a certain value D.

10. The term of “illuminance change” of a video unit may refer to the values of most samples/pixels, and/or the mean value of samples/pixels in the video unit change a lot between two different video units.
a. For example, d=abs(m1−m2) where m1 and m2 denote the output of a function applied to two associated video units.
   i. In one example, the function is defined to be the mean values, e.g., two mean values of samples/pixels in two different video units are calculated as m1 and m2, respectively.
   ii. In one example, illuminance change occurs when d is larger than a certain value D.

11. In above examples, the variable D may be predefined.
a. Alternatively, D may be derived on-the-fly, e.g., according to decoded information (e.g., adjacent or non-adjacent samples/pixels in current picture/different pictures).
b. Alternatively, D may be signalled in a bitstream.

12. In above examples, the video unit may refer to the video unit may refer to colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block(PB)/transform block (TB)/a block/sub-block of a block/sub-region within a block/any other region that contains more than one sample or pixel.
a. In one example, the determination of illuminance change/information may refer to luma component and/or chroma components.

13. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

14. Whether to and/or how to apply the disclosed methods above may be signalled at PB/TB/CB/PU/TU/CU/VPDU/CTU/CTU row/slice/tile/sub-picture/other kinds of region contains more than one sample or pixel.

15. Whether to and/or how to apply the disclosed methods above may be dependent on coded information, such as block size, colour format, single/dual tree partitioning, colour component, slice/picture type.

Embodiments of the present disclosure are related to determining whether to and/or how to apply an optical flow based coding method to a video unit based on illuminance information.

As used herein, the term “video unit” used herein may refer to one or more of: a color component, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block(PB), a transform block (TB), a block, a subblock of a block, a sub-region within the block, or a region that comprises more than one sample or pixel.

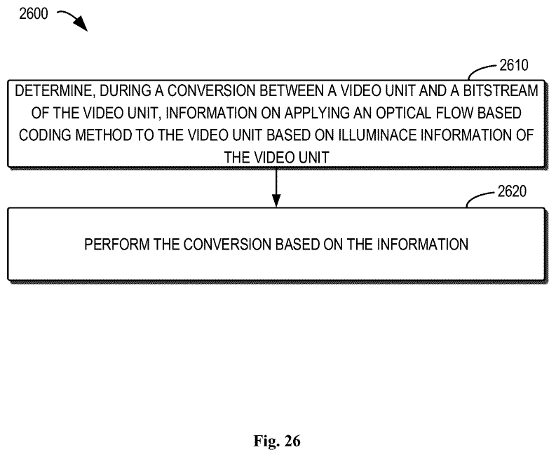

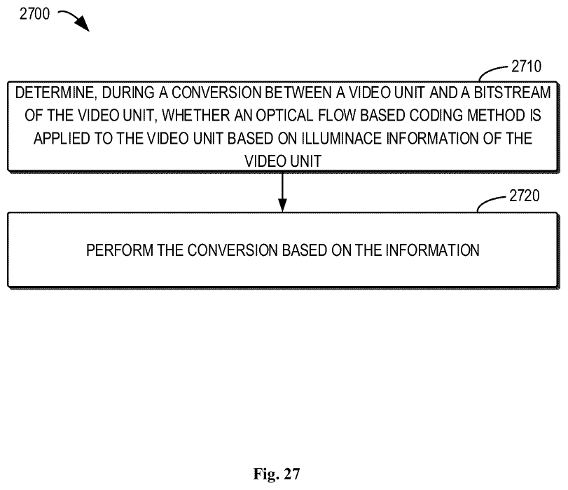

FIG. 26 illustrates a flowchart of a method 2600 for video processing in accordance with some embodiments of the present disclosure. The method 2600 may be implemented during a conversion between a video unit and a bitstream of the video unit.

At block 2610, during a conversion between a video unit and a bitstream of the video unit, information on applying an optical flow based coding method to the video unit is determined based on illuminance information of the video unit. According to embodiments of the present disclosure, the information on applying the optical flow based coding method to the video unit comprises whether to apply the optical flow based coding method to the video unit. According to embodiments of the present disclosure, the information on applying the optical flow based coding method to the video unit comprises how to apply the optical flow based coding method to the video unit.

At block 2620, the conversion is performed based on the information. In some embodiments, the conversion may comprise encoding the video unit into the bitstream. In some embodiments, the conversion may comprise decoding the video unit from the bitstream.

In some embodiments, a bitstream of a video may be stored in a non-transitory computer-readable recording medium. The bitstream of the video can be generated by a method performed by a video processing apparatus. According to the method, information on applying an optical flow based coding method to the video unit is determined based on illuminance information of the video unit, and a bitstream of the video unit is generated based on the information.

In some embodiments, information on applying an optical flow based coding method to the video unit is determined based on illuminance information of the video unit. A bitstream of the video unit is generated based on the information, and the bitstream is stored in a nontransitory computer-readable recording medium.

According to embodiments of the present disclosure, illuminance information can be considered when determining whether to or how to apply an optical flow based coding method. Compared with the conventional solution, some embodiments of the present disclosure can advantageously improve the coding efficiency and coding performance.

FIG. 27 illustrates a flowchart of a method 2700 for video processing in accordance with some embodiments of the present disclosure. The method 2700 may be implemented during a conversion between a video unit and a bitstream of the video unit.

At block 2710, during a conversion between a video unit and a bitstream of the video unit, whether an optical flow based coding method is applied to the video unit is determined based on illuminance information of the video unit.

At block 2720, the conversion is performed based on the determination. In some embodiments, the conversion may comprise encoding the video unit into the bitstream. In some embodiments, the conversion may comprise decoding the video unit from the bitstream.

According to embodiments of the present disclosure, illuminance information can be considered when determining whether to apply an optical flow based coding method. Compared with the conventional solution, some embodiments of the present disclosure can advantageously improve the coding efficiency and coding performance.

In some embodiments, whether to apply the optical flow based coding method to the video unit may depend on whether illuminance change occurs. In some embodiments, if the illuminance change occurs, the optical flow based coding method may not be applied to the video unit. In this way, it can ensure that the optical flow based coding method is applied in a proper scenario.

In some embodiments, whether the illuminance change of the video unit occurs may be determined based on a set of neighbor samples of the video unit. In some embodiments, the set of neighbor samples may be adjacent to the video unit. In some embodiments, the set of neighbor samples may be non-adjacent to the video unit.

In some embodiments, a syntax element in the bitstream may indicate whether the illuminance change occurs. In other words, whether the illuminance change of the video unit occurs may be indicated by a syntax element and signalled in the bitstream. In this way, it can reduce the computation burden at the decoder side when determining whether to apply the optical flow based coding method.

In some embodiments, whether the illuminance change of the video unit occurs may be determined based on whether a coding tool is applied to the video unit. In some embodiments, whether the illuminance change of the video unit occurs may be determined based on how the coding tool is applied to the video unit. In some embodiments, the coding tool may refer to at least one of: a local illumination compensation method, a bi-prediction with CU-level weight method, or affine compensation method. For example, in some embodiments, the coding tool may comprise BCW. In some embodiments, the coding tool may comprise LIC. In some embodiments, if the coding tool is applied, it may mean that the illuminance is changed.

In some embodiments, if the illuminance change occurs on a sample or a pixel of the video unit, the optical flow based coding method may not be applied to the sample or the pixel of the video unit. For example, if the illuminance change occurs on left-top sample(s) or pixel(s), the optical flow based coding method may not be applied to the left-top sample(s) or pixel(s).

In some embodiments, a determination of an illuminance change of the video unit may be performed in a first level. In some embodiments, a determination of whether to and/or how to the optical flow based coding method may be performed in a second level. In some embodiments, the first level and the second level may be both block level. In some embodiments, the first level and the second level may be both picture level. In some embodiments, the first level and the second level may be both sub-block level. In some embodiments, the first level may be block level and the second level may be sub-block level. In some embodiments, all of samples or pixels in the first level may be utilized. In some embodiments, a part of the samples or pixels in the first level may be utilized.

In some embodiments, if the optical flow based coding method is block-level, at least one of detection or a calculation of an illuminance change of the video unit may involve samples in addition to a set of prediction blocks of a current block associated with the video unit. In some embodiments, if the optical flow based coding method is subblock-level, at least one of detection or a calculation of an illuminance change of the video unit may involve samples in addition to a set of prediction blocks of a current subblock associated with the video unit in a block.

In some embodiments, whether the optical flow based coding method is applied to the video unit may be determined based on at least one of: whether a coding tool is applied to the video unit, or how the coding tool is applied to the video unit. In some embodiments, the coding tool may refer to at least one of: a local illumination compensation method, a bi-prediction with CU-level weight method, or affine compensation method. For example, in some embodiments, the coding tool may comprise BCW. In some embodiments, if the the coding tool is applied to the video unit, the optical flow based coding method may not be applied to the video unit. In some embodiments, if the coding tool is applied to the video unit, the optical flow based coding method may be applied to the video unit.

In some embodiments, the optical flow based coding method may refer to at least one of: a bi-directional optical flow method in which an optical flow is used to refine a bi-prediction signal of a coding block, a prediction refinement with optical flow for affine mode in which the optical flow is used to refine an affine motion compensated prediction, or a coding method in which the optical flow is used to generate or refine a prediction/reconstruction signal of a coding block. In some embodiments, the optical flow based coding method may be a bi-directional optical flow (BDOF). In some embodiments, the optical flow based coding method may be a prediction refinement with optical flow (PROF).

In some embodiments, the illuminance change of a sample/pixel may refer to the sample/pixel value changes a lot between two different video units (e.g., current picture and its reference picture). In some embodiments, if a change of sample or pixel values between two video units is larger than a first threshold value, an illuminance change may occur. For example. the change may be calculated by d=abs(P1−P2) where P1 and P2 denote two samples/pixels in two different video units and abs represents an absolute value operation. In this case, illuminance change may occur if d is larger than a certain value D. In some embodiments, the first threshold value may be predefined. In some embodiments, the first threshold value may be derived dynamically. For example, the first threshold value may be derived according to decoded information (e.g., adjacent or non-adjacent samples/pixels in current picture/different pictures). In some embodiments, the first threshold value may be indicated in the bitstream.

In some embodiments, the illuminance change of a video unit may refer to the values of most samples/pixels, and/or the mean value of samples/pixels in the video unit change a lot between two different video units. In some embodiments, if a change of sample or pixel values in the video unit between two video units is larger than a second threshold value, an illuminance change occurs. In some embodiments, if a change of mean values of ample or pixel values in the video unit between two video units is larger than the second threshold value, the illuminance change may occur. For example, the change may be calculated by d=abs(m1−m2), where m1 and m2 denote the output of a function applied to two associated video units and abs represents an absolute value operation. In some embodiments, the the function may be defined to be mean values. For example, two mean values of samples/pixels in two different video units are calculated as m1 and m2, respectively. In some embodiments, the second threshold value may be predefined. In some embodiments, the second threshold value may be derived dynamically. For example, the second threshold value may be derived according to decoded information (e.g., adjacent or non-adjacent samples/pixels in current picture/different pictures). In some embodiments, the second threshold value may be indicated in the bitstream.

In some embodiments, the illuminance information or an illuminance change of the video unit may comprise at least one of: a luma component, or a chroma component.

In some embodiments, an indication of whether to apply the optical flow based coding method may be indicated at one of the followings: sequence level, group of pictures level, picture level, slice level, or tile group level. For example, in some embodiments, the indication of whether to apply the optical flow based coding method may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to apply the optical flow based coding method may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture, or a region containing more than one sample or pixel.

In some embodiments, whether the optical flow based coding method is applied may be determined based on coded information of the video unit. The coded information may comprise at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, whether an optical flow based coding method is applied to the video unit is determined based on illuminance information of the video unit, and a bitstream of the video unit is generated based on the determination.

In some embodiments, whether an optical flow based coding method is applied to the video unit is determined based on illuminance information of the video unit. A bitstream of the video unit is generated based on the determination, and the bitstream is stored in a non-transitory computer-readable recording medium.

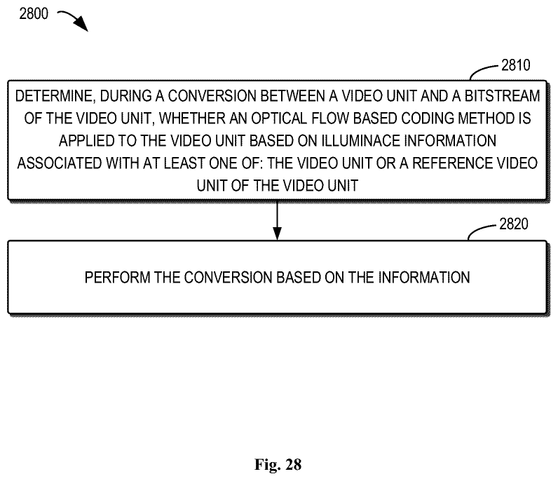

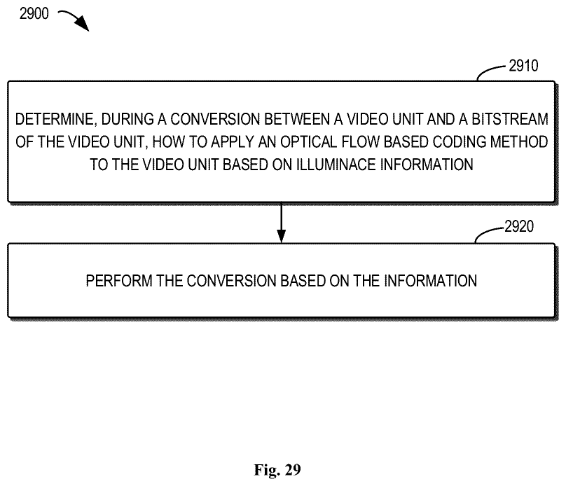

FIG. 28 illustrates a flowchart of a method 2800 for video processing in accordance with some embodiments of the present disclosure. The method 2800 may be implemented during a conversion between a video unit and a bitstream of the video unit.

At block 2810, during a conversion between a video unit and a bitstream of the video unit, whether an optical flow based coding method is applied to the video unit is determined based on illuminance information associated with at least one of: the video unit or a reference video unit of the video unit.

At block 2820, the conversion is performed based on the determination. In some embodiments, the conversion may comprise encoding the video unit into the bitstream. In some embodiments, the conversion may comprise decoding the video unit from the bitstream.

According to embodiments of the present disclosure, illuminance information can be considered when determining whether to apply an optical flow based coding method. Compared with the conventional solution, some embodiments of the present disclosure can advantageously improve the coding efficiency and coding performance.

In some embodiments, whether to enable the optical flow based coding method may be determined based on illuminance information of two reference pictures of the video unit. In some embodiments, if an illuminance change occurs between the two reference pictures, it may be disallowed to enable the optical flow based coding method.

In some embodiments, a first reference picture in the two reference pictures may be from a first list of reference pictures, and and a second reference picture in the two reference pictures may be from a second list of reference pictures. For example, one of the two reference pictures may be from list X, and the other may be from list Y.

In some embodiments, an absolute picture order coding (POC) distance of the two reference pictures may be equal to twice of an absolute POC distance of one of the two reference pictures relative to the video unit. For example, the current picture of the video unit may be in the middle between the two reference pictures in terms of POC.

In some embodiments, all of samples or pixels in the two reference pictures may be used for determining the illuminance information. In some embodiment, a part of the samples or pixels in the two reference pictures may be used for determining the illuminance information.

In some embodiments, whether to enable the optical flow based coding method may be determined based on illuminance information of a current picture and one or more reference pictures associated with the video unit.

In some embodiments, whether an illuminance change of the video unit occurs may be determined based on the current picture and one or more reference pictures. In some embodiments, whether the illuminance change of the video unit occurs may be determined based on at least one of: an original sample in the one or more reference pictures or a reconstructed sample in the one or more reference pictures.

In some embodiments, whether the illuminance change of the video unit occurs may be determined based on at least one of: an original sample of the current picture, a reconstructed sample of the current picture, or a prediction sample of the current picture.

In some embodiments, a set of histograms for the one or more reference pictures may be determined. In this case, in some embodiments, if a difference of the set of histograms is larger than a first threshold value, the illuminance change may occur. In some embodiments, the first threshold value may be set based on at least one of: a size of the current picture, coding information of the video unit, the current picture, or the set of histograms.

In some embodiments, if an illuminance change occurs among the current picture and the one or more reference pictures, it may not to enable the optical flow based coding method.

In some embodiments, the illuminance information may comprise a sample value of one or more components between the video unit and the reference video unit of the video unit. In some embodiments, the one or more components comprise a luma component. In some embodiments, the one or more components may comprise one or more chroma components. In some embodiments, the video unit and/or the reference video unit may be a coding block, such as coding unit/prediction unit/transform unit.

In some embodiments, a first feature of sample value for the video unit may be determined. In some embodiments, a second feature of sample value for the reference video unit may be determined. In some embodiments, if a difference between the first feature and the second feature is larger than a second threshold value, it may determine not to apply the optical flow based coding method. In some embodiments, the first feature may be determined based on a neighboring sample of the video unit. In some embodiments, the neighboring sample may be adjacent to the video unit. In some embodiments, the neighboring sample may be nonadjacent to the video unit. In some embodiments, a prediction signal for the video unit may be derived. In this case, the first feature may be determined based on the prediction signal. In some embodiments, the prediction signal may be a intra prediction signal. In some embodiments, the second feature may be determined based on a reconstructed sample of the reference video unit.

In some embodiments, the first feature may comprise at least one of: a mean value of sample value for the video unit, a variance value of sample value for the video unit, or a histogram of sample values for the video unit.

In some embodiments, the second feature may comprise at least one of: a mean value of sample value for the reference video unit, a variance value of sample value for the reference video unit, or a histogram of sample values for the reference video unit.

In some embodiments, the second threshold value may be determined based on coding information of the video unit. In some embodiments, the coding information may comprise at least one of: a dimension of the video unit, or a size of the video unit.

In some embodiments, a determination of an illuminance change of the video unit may be performed in a first level. In some embodiments, a determination of whether to and/or how to the optical flow based coding method may be performed in a second level. In some embodiments, the first level and the second level may be both block level. In some embodiments, the first level and the second level may be both picture level. In some embodiments, the first level and the second level may be both sub-block level. In some embodiments, the first level may be block level and the second level may be sub-block level. In some embodiments, all of samples or pixels in the first level may be utilized. In some embodiments, a part of the samples or pixels in the first level may be utilized.

In some embodiments, if the optical flow based coding method is block-level, at least one of detection or a calculation of an illuminance change of the video unit may involve samples in addition to a set of prediction blocks of a current block associated with the video unit. In some embodiments, if the optical flow based coding method is subblock-level, at least one of detection or a calculation of an illuminance change of the video unit may involve samples in addition to a set of prediction blocks of a current subblock associated with the video unit in a block.

In some embodiments, the optical flow based coding method may refer to at least one of: a bi-directional optical flow method in which an optical flow is used to refine a bi-prediction signal of a coding block, a prediction refinement with optical flow for affine mode in which the optical flow is used to refine an affine motion compensated prediction, or a coding method in which the optical flow is used to generate or refine a prediction/reconstruction signal of a coding block. In some embodiments, the optical flow based coding method may be a bi-directional optical flow (BDOF). In some embodiments, the optical flow based coding method may be a prediction refinement with optical flow (PROF).

In some embodiments, the illuminance change of a sample/pixel may refer to the sample/pixel value changes a lot between two different video units (e.g., current picture and its reference picture). In some embodiments, if a change of sample or pixel values between two video units is larger than a first threshold value, an illuminance change may occur. For example, the change may be calculated by d=abs(P1−P2) where P1 and P2 denote two samples/pixels in two different video units and abs represents an absolute value operation. In this case, illuminance change may occur if d is larger than a certain value D. In some embodiments, the first threshold value may be predefined. In some embodiments, the first threshold value may be derived dynamically. For example, the first threshold value may be derived according to decoded information (e.g., adjacent or non-adjacent samples/pixels in current picture/different pictures). In some embodiments, the first threshold value may be indicated in the bitstream.

In some embodiments, the illuminance change of a video unit may refer to the values of most samples/pixels, and/or the mean value of samples/pixels in the video unit change a lot between two different video units. In some embodiments, if a change of sample or pixel values in the video unit between two video units is larger than a second threshold value, an illuminance change occurs. In some embodiments, if a change of mean values of ample or pixel values in the video unit between two video units is larger than the second threshold value, the illuminance change may occur. For example, the change may be calculated by d=abs(m1−m2), where m1 and m2 denote the output of a function applied to two associated video units and abs represents an absolute value operation. In some embodiments, the the function may be defined to be a derivation of mean values. For example, two mean values of samples/pixels in two different video units are calculated as m1 and m2, respectively. In some embodiments, the second threshold value may be predefined. In some embodiments, the second threshold value may be derived dynamically. For example, the second threshold value may be derived according to decoded information (e.g., adjacent or non-adjacent samples/pixels in current picture/different pictures). In some embodiments, the second threshold value may be indicated in the bitstream.

In some embodiments, the illuminance information or an illuminance change of the video unit may comprise at least one of: a luma component, or a chroma component.

In some embodiments, an indication of whether to apply the optical flow based coding method may be indicated at one of the followings: sequence level, group of pictures level, picture level, slice level, or tile group level. For example, in some embodiments, the indication of whether to apply the optical flow based coding method may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to apply the optical flow based coding method may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, whether the optical flow based coding method is applied may be determined based on coded information of the video unit. The coded information may comprise at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, whether an optical flow based coding method is applied to the video unit is determined based on illuminance information associated with at least one of: the video unit or a reference video unit of the video unit. and a bitstream of the video unit is generated based on the determination.

In some embodiments, whether an optical flow based coding method is applied to the video unit is determined based on illuminance information associated with at least one of: the video unit or a reference video unit of the video unit. A bitstream of the video unit is generated based on the determination, and the bitstream is stored in a non-transitory computer-readable recording medium.

FIG. 29 illustrates a flowchart of a method 2900 for video processing in accordance with some embodiments of the present disclosure. The method 2900 may be implemented during a conversion between a video unit and a bitstream of the video unit.

At block 2910, during a conversion between a video unit and a bitstream of the video unit, how to apply an optical flow based coding method to the video unit is determined based on illuminance information associated with at least one of: the video unit or a reference video unit of the video unit.

At block 2920, the conversion is performed based on the determination. In some embodiments, the conversion may comprise encoding the video unit into the bitstream. In some embodiments, the conversion may comprise decoding the video unit from the bitstream.

According to embodiments of the present disclosure, illuminance information can be considered when determining how to apply an optical flow based coding method. Compared with the conventional solution, some embodiments of the present disclosure can advantageously improve the coding efficiency and coding performance.

In some embodiments, the optical flow based coding process may be applied to the video unit based on whether an illuminance change of the video unit occurs. In some embodiments, the illuminance change may be included in a process of the optical flow based coding method.

In some embodiments, a value may be subtracted in calculation of a gradient in the process of the optical flow based coding method.

In some embodiments, during the process of the optical flow based coding method, a first value may be subtracted from a first sample or pixel in a first prediction block of the video unit. In some embodiments, a second value may be subtracted from a second sample or pixel in a second prediction block of the video unit. In some embodiments, a difference of the first sample or pixel and the second sample or pixel may be determined.

In some embodiments, a prediction block of the video unit may be revised via a function used in the optical flow based coding method. In some embodiments, the function may be a linear function: f(Pi)=a*Pi+b, where a and b represent linear parameters, respectively, and Pi represents a sample or pixel in the prediction block of the video unit. Instead of using the first/second prediction blocks directly obtained from motion information, it is proposed to firstly revise the obtained prediction blocks via a function, i.e. f(Pi) is used in the optical flow procedure, instead of the sample value Pi.

In some embodiments, at least one of the linear parameters may be determined based on one of: a coding tool (for example, LIC and/or BCW), or a set of neighbor samples or pixels of the video unit. In some embodiments, at least one of the linear parameters may be indicated in the bitstream. In some embodiments, the function may be different for different prediction blocks of the video unit.

In some embodiments, the function may be a non-linear function. In some embodiments, a set of model parameters of the illuminance change may be jointly optimized with a set of parameters of the optical flow based coding method. In some embodiments, the set of model parameters of the illuminance change and the set of parameters of the optical flow based coding method may be updated with least square regression method iteratively.

In some embodiments, a determination of an illuminance change of the video unit may be performed in a first level, and a determination of how to the optical flow based coding method may be performed in a second level.

In some embodiments, the first level and the second level may be both block level. In some embodiments, the first level and the second level may be both picture level. In some embodiments, the first level and the second level may be both sub-block level. In some embodiments, the first level may be block level and the second level may be sub-block level. In some embodiments, all of samples or pixels in the first level may be utilized. In some embodiments, a part of the samples or pixels in the first level may be utilized.

In some embodiments, an indication of how to apply the optical flow based coding method may be indicated at one of the followings: sequence level, group of pictures level, picture level, slice level, or tile group level. For example, in some embodiments, the indication of how to apply the optical flow based coding method may be indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of how to apply the optical flow based coding method may be included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture, or a region containing more than one sample or pixel.

In some embodiments, how the optical flow based coding method is applied may be determined based on based on coded information of the video unit. The coded information may comprise at least one of: a block size, a colour format, a single and/or dual tree partitioning, a colour component, a slice type, or a picture type.

In some embodiments, a bitstream of a video may be stored in a non-transitory computer-readable recording medium. The bitstream of the video can be generated by a method performed by a video processing apparatus. According to the method, how to apply an optical flow based coding method to the video unit is determined based on illuminance information associated with at least one of: the video unit or a reference video unit of the video unit, and a bitstream of the video unit is generated based on the determination.

In some embodiments, how to apply an optical flow based coding method to the video unit is determined based on illuminance information associated with at least one of: the video unit or a reference video unit of the video unit. A bitstream of the video unit is generated based on the determination, and the bitstream is stored in a non-transitory computer-readable recording medium.

Implementations of the present disclosure can be described in view of the following clauses, the features of which can be combined in any reasonable manner.

Clause 1. A method of video processing, comprising: determining, during a conversion between a video unit and a bitstream of the video unit, whether an optical flow based coding method is applied to the video unit based on illuminance information associated with at least one of: the video unit or a reference video unit of the video unit; and performing the conversion based on the determination.

Clause 2. The method of clause 1, wherein determining whether the optical flow based coding method is applied to the video unit comprises: determining whether to enable the optical flow based coding method based on illuminance information of two reference pictures of the video unit.

Clause 3. The method of clause 2, further comprising: in response to that an illuminance change occurs between the two reference pictures, determining not to enable the optical flow based coding method.

Clause 4. The method of clause 2, wherein a first reference picture in the two reference pictures is from a first list of reference pictures, and a second reference picture in the two reference pictures is from a second list of reference pictures.

Clause 5. The method of clause 2, wherein an absolute picture order coding (POC) distance of the two reference pictures is equal to twice of an absolute POC distance of one of the two reference pictures relative to the video unit.

Clause 6. The method of clause 2, wherein all of samples or pixels in the two reference pictures are used for determining the illuminance information, or wherein a part of the samples or pixels in the two reference pictures are used for determining the illuminance information.

Clause 7. The method of clause 1, wherein determining whether the optical flow based coding method is applied to the video unit comprises: determining whether to enable the optical flow based coding method based on illuminance information of a current picture and one or more reference pictures associated with the video unit.

Clause 8. The method of clause 7, further comprising: determining whether an illuminance change of the video unit occurs based on the current picture and one or more reference pictures.

Clause 9. The method of clause 8, wherein determining whether the illuminance change of the video unit occurs comprises: determining whether the illuminance change of the video unit occurs based on at least one of: an original sample in the one or more reference pictures or a reconstructed sample in the one or more reference pictures.

Clause 10. The method of clause 8, wherein determining whether the illuminance change of the video unit occurs comprises: determining whether the illuminance change of the video unit occurs based on at least one of: an original sample of the current picture, a reconstructed sample of the current picture, or a prediction sample of the current picture.

Clause 11. The method of clause 8, further comprising: determining a set of histograms for the one or more reference pictures: and in response to that a difference of the set of histograms is larger than a first threshold value, determining that the illuminance change occurs.

Clause 12. The method of clause 11, wherein the first threshold value is set based on at least one of: a size of the current picture, coding information of the video unit, the current picture, or the set of histograms.

Clause 13. The method of clause 7, further comprising: in response to that an illuminance change occurs among the current picture and the one or more reference pictures, determining not to enable the optical flow based coding method.

Clause 14. The method of clause 1, wherein the illuminance information comprises a sample value of one or more components between the video unit and the reference video unit of the video unit.

Clause 15. The method of clause 14, wherein the one or more components comprise a luma component.

Clause 16. The method of clause 14, wherein the one or more components comprise one or more chroma components.

Clause 17. The method of clause 1, further comprising: determining a first feature of sample value for the video unit; determining a second feature of sample value for the reference video unit; and in response to that a difference between the first feature and the second feature is larger than a second threshold value, determining not to apply the optical flow based coding method.

Clause 18. The method of clause 17, wherein the first feature is determined based on a neighboring sample of the video unit.

Clause 19. The method of clause 17, wherein determining the first feature comprises: deriving a prediction signal for the video unit; and determining the first feature based on the prediction signal.

Clause 20. The method of clause 17, wherein the second feature is determined based on a reconstructed sample of the reference video unit.

Clause 21. The method of clause 17, wherein the first feature comprises at least one of: a mean value of sample value for the video unit, a variance value of sample value for the video unit, or a histogram of sample values for the video unit.

Clause 22. The method of clause 17, wherein the second feature comprises at least one of: a mean value of sample value for the reference video unit, a variance value of sample value for the reference video unit, or a histogram of sample values for the reference video unit.

Clause 23. The method of clause 17, wherein the second threshold value is determined based on coding information of the video unit.

Clause 24. The method of clause 23, wherein the coding information comprises at least one of: a dimension of the video unit, or a size of the video unit.

Clause 25. The method of clause 1, wherein the optical flow based coding method comprises at least one of: a bi-directional optical flow method in which an optical flow is used to refine a bi-prediction signal of a coding block, a prediction refinement with optical flow for affine mode in which the optical flow is used to refine an affine motion compensated prediction, or a coding method in which the optical flow is used to generate or refine a prediction/reconstruction signal of a coding block.

Clause 26. The method of clause 25, wherein the optical flow based coding method is a bi-directional optical flow (BDOF), or wherein the optical flow based coding method is a prediction refinement with optical flow (PROF).

Clause 27. The method of clause 1, wherein if a change of sample or pixel values between the video unit and the reference video unit is larger than a third threshold value, an illuminance change occurs.

Clause 28. The method of clause 27, wherein the change is calculated by: d=abs(P1−P2), wherein P1 and P2 represent two samples or pixels in the video unit and the reference video unit, respectively, and abs represents an absolute value operation.

Clause 29. The method of clause 27, wherein the third threshold value is predefined, or wherein the third threshold value is determined dynamically, or wherein the third threshold value is indicated in the bitstream.

Clause 30. The method of clause 1, wherein if a change of sample or pixel values in the video unit between the video unit and the reference video unit is larger than a fourth threshold value, an illuminance change occurs, or wherein if a change of mean values of ample or pixel values in the video unit between the video unit and the reference video unit is larger than the fourth threshold value, the illuminance change occurs.

Clause 31. The method of clause 30, wherein the change is calculated by: d=abs(m1−m2), wherein P1 and P2 represent output of a function applied to the two associated video units, respectively, and abs represents an absolute value operation.

Clause 32. The method of clause 31, wherein the function is defined to be a derivation mean values.

Clause 33. The method of clause 30, wherein the fourth threshold value is predefined, or wherein the fourth threshold value is determined dynamically, or wherein the fourth threshold value is indicated in the bitstream.

Clause 34. The method of clause 1, wherein the video unit comprises one of: a picture, a sub-picture, a slice, a tile, a coding tree unit (CTU), a CTU row, a group of CTUs, a coding unit (CU), a prediction unit (PU), a transform unit (TU), a coding tree block (CTB), a coding block (CB), a prediction block (PB), a transform block (TB), a block, a sub-block of a block, a sub-region within the block, or a region that comprises more than one sample or pixel.

Clause 35. The method of clause 1, wherein the conversion includes encoding the video unit into the bitstream.

Clause 36. The method of clause 1, wherein the conversion includes decoding the video unit from the bitstream.

Clause 37. The method of any of clauses 1-40, wherein an indication of whether to and/or how to apply the optical flow based coding method is indicated at one of the followings: sequence level, group of pictures level, picture level, slice level, or tile group level.

Clause 38. The method of any of clauses 1-37, wherein an indication of whether to and/or how to apply the optical flow based coding method is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 39. The method of any of clauses 1-37, wherein an indication of whether to and/or how to apply the optical flow based coding method is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 40. The method of any of clauses 1-37, further comprising: determining, based on coded information of the video unit, whether and/or how the optical flow based coding method is applied, the coded information including at least one of: a block size, a colour format, a single and/or dual tree partitioning, a colour component, a slice type, or a picture type.

Clause 41. An apparatus for processing video data comprising a processor and a non-transitory memory with instructions thereon, wherein the instructions upon execution by the processor, cause the processor to perform a method in accordance with any of clauses 1-40.

Clause 42. A non-transitory computer-readable storage medium storing instructions that cause a processor to perform a method in accordance with any of clauses 1-40.

Clause 43. A non-transitory computer-readable recording medium storing a bitstream of a video which is generated by a method performed by a video processing apparatus, wherein the method comprises: determining whether an optical flow based coding method is applied to a video unit based on illuminance information associated with at least one of: the video unit or a reference video unit of the video unit: and generating the bitstream of the video unit based on the determining.

Clause 44. A method for storing bitstream of a video, comprising: determining whether an optical flow based coding method is applied to a video unit based on illuminance information associated with at least one of: the video unit or a reference video unit of the video unit: generating a bitstream of the video unit based on the determining: and storing the bitstream in a non-transitory computer-readable recording medium.

### Example Device

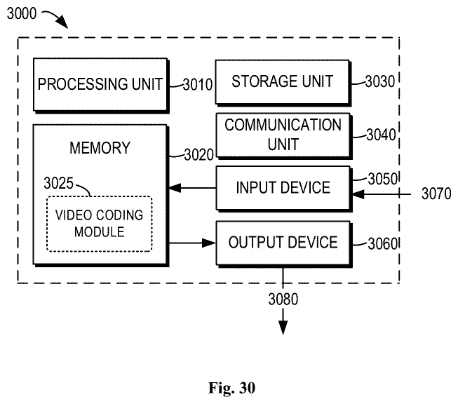

FIG. 30 illustrates a block diagram of a computing device 3000 in which various embodiments of the present disclosure can be implemented. The computing device 3000 may be implemented as or included in the source device 110 (or the video encoder 114 or 200) or the destination device 120 (or the video decoder 124 or 300).

It would be appreciated that the computing device 3000 shown in FIG. 30 is merely for purpose of illustration, without suggesting any limitation to the functions and scopes of the embodiments of the present disclosure in any manner.

As shown in FIG. 30, the computing device 3000 includes a general-purpose computing device 3000. The computing device 3000 may at least comprise one or more processors or processing units 3010, a memory 3020, a storage unit 3030, one or more communication units 3040, one or more input devices 3050, and one or more output devices 3060.

In some embodiments, the computing device 3000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3000 can support any type of interface to a user (such as “wearable” circuitry and the like).

The processing unit 3010 may be a physical or virtual processor and can implement various processes based on programs stored in the memory 3020. In a multi-processor system, multiple processing units execute computer executable instructions in parallel so as to improve the parallel processing capability of the computing device 3000. The processing unit 3010 may also be referred to as a central processing unit (CPU), a microprocessor, a controller or a microcontroller.

The computing device 3000 typically includes various computer storage medium. Such medium can be any medium accessible by the computing device 3000, including, but not limited to, volatile and non-volatile medium, or detachable and non-detachable medium. The memory 3020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3030 may be any detachable or non-detachable medium and may include a machine-readable medium such as a memory, flash memory drive, magnetic disk or another other media, which can be used for storing information and/or data and can be accessed in the computing device 3000.

The computing device 3000 may further include additional detachable/non-detachable, volatile/non-volatile memory medium. Although not shown in FIG. 30, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3040 communicates with a further computing device via the communication medium. In addition, the functions of the components in the computing device 3000 can be implemented by a single computing cluster or multiple computing machines that can communicate via communication connections. Therefore, the computing device 3000 can operate in a networked environment using a logical connection with one or more other servers, networked personal computers (PCs) or further general network nodes.

The input device 3050 may be one or more of a variety of input devices, such as a mouse, keyboard, tracking ball, voice-input device, and the like. The output device 3060 may be one or more of a variety of output devices, such as a display, loudspeaker, printer, and the like. By means of the communication unit 3040, the computing device 3000 can further communicate with one or more external devices (not shown) such as the storage devices and display device, with one or more devices enabling the user to interact with the computing device 3000, or any devices (such as a network card, a modem and the like) enabling the computing device 3000 to communicate with one or more other computing devices, if required. Such communication can be performed via input/output (I/O) interfaces (not shown).

In some embodiments, instead of being integrated in a single device, some or all components of the computing device 3000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example. a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3000 may be used to implement video encoding/decoding in embodiments of the present disclosure. The memory 3020 may include one or more video coding modules 3025 having one or more program instructions. These modules are accessible and executable by the processing unit 3010 to perform the functionalities of the various embodiments described herein.

In the example embodiments of performing video encoding, the input device 3050 may receive video data as an input 3070 to be encoded. The video data may be processed, for example, by the video coding module 3025, to generate an encoded bitstream. The encoded bitstream may be provided via the output device 3060 as an output 3080.

In the example embodiments of performing video decoding, the input device 3050 may receive an encoded bitstream as the input 3070. The encoded bitstream may be processed, for example, by the video coding module 3025, to generate decoded video data. The decoded video data may be provided via the output device 3060 as the output 3080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

1-44. (canceled)

45. A method of video processing, comprising:
determining, during a conversion between a video unit and a bitstream of the video unit, whether an optical flow based coding method is applied to the video unit based on illuminance information associated with at least one of: the video unit or a reference video unit of the video unit; and
performing the conversion based on the determination.

46. The method of claim 45, wherein determining whether the optical flow based coding method is applied to the video unit comprises:
determining whether to enable the optical flow based coding method based on illuminance information of two reference pictures of the video unit.

47. The method of claim 46, wherein the method further comprises: in response to that an illuminance change occurs between the two reference pictures, determining not to enable the optical flow based coding method, or
wherein a first reference picture in the two reference pictures is from a first list of reference pictures, and a second reference picture in the two reference pictures is from a second list of reference pictures, or
wherein an absolute picture order coding (POC) distance of the two reference pictures is equal to twice of an absolute POC distance of one of the two reference pictures relative to the video unit, or
wherein all of samples or pixels in the two reference pictures are used for determining the illuminance information, or
wherein a part of the samples or pixels in the two reference pictures are used for determining the illuminance information.

48. The method of claim 45, wherein determining whether the optical flow based coding method is applied to the video unit comprises:
determining whether to enable the optical flow based coding method based on illuminance information of a current picture and one or more reference pictures associated with the video unit.

49. The method of claim 48, further comprising:
determining whether an illuminance change of the video unit occurs based on the current picture and one or more reference pictures.

50. The method of claim 49, wherein determining whether the illuminance change of the video unit occurs comprises: determining whether the illuminance change of the video unit occurs based on at least one of: an original sample in the one or more reference pictures or a reconstructed sample in the one or more reference pictures, or
wherein determining whether the illuminance change of the video unit occurs comprises: determining whether the illuminance change of the video unit occurs based on at least one of: an original sample of the current picture, a reconstructed sample of the current picture, or a prediction sample of the current picture, or
wherein the method further comprises:
determining a set of histograms for the one or more reference pictures; and
in response to that a difference of the set of histograms is larger than a first threshold value, determining that the illuminance change occurs.

51. The method of claim 45, wherein the illuminance information comprises a sample value of one or more components between the video unit and the reference video unit of the video unit.

52. The method of claim 45, further comprising:
determining a first feature of sample value for the video unit;
determining a second feature of sample value for the reference video unit; and
in response to that a difference between the first feature and the second feature is larger than a second threshold value, determining not to apply the optical flow based coding method.

53. The method of claim 52, wherein the first feature is determined based on a neighboring sample of the video unit, or
wherein determining the first feature comprises:
deriving a prediction signal for the video unit; and
determining the first feature based on the prediction signal, or
wherein the second feature is determined based on a reconstructed sample of the reference video unit, or
wherein the first feature comprises at least one of: a mean value of sample value for the video unit, a variance value of sample value for the video unit, or a histogram of sample values for the video unit, or
wherein the second feature comprises at least one of: a mean value of sample value for the reference video unit, a variance value of sample value for the reference video unit, or a histogram of sample values for the reference video unit, or
wherein the second threshold value is determined based on coding information of the video unit.

54. The method of claim 45, wherein the optical flow based coding method comprises at least one of:
a bi-directional optical flow method in which an optical flow is used to refine a bi-prediction signal of a coding block,
a prediction refinement with optical flow for affine mode in which the optical flow is used to refine an affine motion compensated prediction, or
a coding method in which the optical flow is used to generate or refine a prediction/reconstruction signal of a coding block.

55. The method of claim 54, wherein the optical flow based coding method is a bi-directional optical flow (BDOF), or
wherein the optical flow based coding method is a prediction refinement with optical flow (PROF).

56. The method of claim 45, wherein if a change of sample or pixel values between the video unit and the reference video unit is larger than a third threshold value, an illuminance change occurs.

57. The method of claim 56, wherein the change is calculated by:
$$d = abs ( P 1 - P 2 ) ,$$
wherein P1 and P2 represent two samples or pixels in the video unit and the reference video unit, respectively, and abs represents an absolute value operation.

58. The method of claim 56, wherein the third threshold value is predefined, or
wherein the third threshold value is determined dynamically, or
wherein the third threshold value is indicated in the bitstream.

59. The method of claim 45, wherein if a change of sample or pixel values in the video unit between the video unit and the reference video unit is larger than a fourth threshold value, an illuminance change occurs, or
wherein if a change of mean values of ample or pixel values in the video unit between the video unit and the reference video unit is larger than the fourth threshold value, the illuminance change occurs.

60. The method of claim 59, wherein the change is calculated by:
$$d = abs ( m 1 - m 2 ) ,$$
wherein P1 and P2 represent output of a function applied to the two associated video units, respectively, and abs represents an absolute value operation.

61. The method of claim 59, wherein the fourth threshold value is predefined, or
wherein the fourth threshold value is determined dynamically, or
wherein the fourth threshold value is indicated in the bitstream.

62. The method of claim 45, wherein the conversion includes encoding the video unit into the bitstream, or wherein the conversion includes decoding the video unit from the bitstream.

63. An apparatus for processing video data comprising:
a processor; and
a non-transitory memory with instructions thereon,
wherein the instructions upon execution by the processor, cause the processor to perform acts comprising:
determining, during a conversion between a video unit and a bitstream of the video unit, whether an optical flow based coding method is applied to the video unit based on illuminance information associated with at least one of: the video unit or a reference video unit of the video unit; and
performing the conversion based on the determination.

64. A non-transitory computer-readable storage medium storing instructions that cause a processor to perform acts comprising:
determining, during a conversion between a video unit and a bitstream of the video unit, whether an optical flow based coding method is applied to the video unit based on illuminance information associated with at least one of: the video unit or a reference video unit of the video unit; and
performing the conversion based on the determination.
